(19) United States
(12) Patent Application Publication
(10) Pub. No.: US 2015/0213541 A1
(43) Pub. Date: Jul. 30, 2015

(54) METHOD FOR VENDING SELF-ASSEMBLY KIT ASSOCIATED WITH FLOWER PRODUCT ON WEBSITE

(71) Applicant: Bloominous Inc., Los Angeles, CA (US)

(72) Inventor: Richard Lim, Los Angeles, CA (US)

(21) Appl. No.: 14/681,053

(22) Filed: Apr. 7, 2015

Related U.S. Application Data
(63) Continuation of application No. 14/591,940, filed on Jan. 8, 2015.
(60) Provisional application No. 61/926,334, filed on Jan. 12, 2014.

(51) Int. Cl. G06Q 30/06; G06Q 10/08

(52) U.S. Cl. CPC G06Q 30/0633; G06Q 30/0637; G06Q 10/083

(57) ABSTRACT

A method of vending a do-it-yourself (DIY) kit associated with a flower product includes: (1) providing an item representing the flower product on an online platform such as website, (2) receiving a purchase order for the item from the online platform, (3) preparing the DIY kit based on the purchase order, and (4) shipping the DIY kit and an instruction manual. The DIY kit includes unassembled parts of various plants (such as one, two or more types of fresh flowers and one, two or more types of flowering plants or leaves) and various non-plant materials (including, e.g., a rubber band, a ribbon, a metal wire, a pin, a tape, a tree branch, a glass orb, a floral foam, and a container) unassembled with the various plants. The flower product is completed using the various plants and the various non-plant materials based on the instruction manual.

This application is a continuation of application Ser. No. 14/591,940, filed Jan. 8, 2015, now pending, which claims the benefit of U.S. provisional application Ser. No. 61/926,334 filed Jan. 12, 2014.

### BACKGROUND OF THE DISCLOSURE

1. Field of the Disclosure

The disclosure relates to a method of vending a kit associated with a flower product, and more particularly, to a method of vending or selling a do-it-yourself (DIY) or self-assembly kit associated with a flower product on a website or online platform.

2. Brief Description of the Related Art

Online shopping, a type of electronic commerce, allows shoppers to buy products from a seller over the Internet using a browser. Online shopping is convenient, easy, and quick and is driving structural changes in the retail model. The growth of online shopping is expected to outpace sales growth at bricks-and-mortar stores.

### SUMMARY OF THE DISCLOSURE

The present invention provides an objective for a customer easily assembling unassembled parts of a kit associated with a flower product based on a floral design by himself or herself.

The present invention provides methods of vending or selling unassembled parts of a do-it-yourself (DIY) or self-assembly kit associated with a flower product on an online platform (such as a website) through a computer network such as the internet.

The present invention provides a network system for vending or selling unassembled parts of a do-it-yourself (DIY) or self-assembly kit associated with a flower product.

An exemplary embodiment of the present disclosure provides a method of vending or selling a do-it-yourself (DIY) kit, or an unassembled or self-assembly kit, associated with a flower product, the method including: (1) providing an item representing the flower product on an online platform (e.g., an online or web shop, an online or web store, or a website), (2) receiving a purchase order for the item from the online platform, wherein the purchase order may be submitted through the online platform, (3) acknowledging the purchase order via the online platform or email, (4) sending a request associated with the DIY kit for the item to a supplier based on the purchase order, (5) preparing the DIY kit and an instruction manual based on the request, and (6) shipping the DIY kit and the instruction manual. The item may include a text associated with the flower product, a video associated with the flower product, and an image (or picture) of the flower product, and the text, the video and the image are presented on the online platform. The DIY kit may include unassembled parts of various plants (including, e.g., one, two or more types of fresh flowers and one, two or more types of flowering plants or leaves) and one or more non-plant materials (including, e.g., a rubber band, a ribbon, a metal wire, a pin, a (floral) tape, a tree branch, a glass orb, a piece of foam, and a container) unassembled with the various plants. The one, two or more types of fresh flowers may include agapanthus, allium, alstroemeria, amaryllis, anemones, anthurium, asclepiad, asters, astilbe, baby's breath, bouvardia, calla lilies, campanulas, carnations, celosia, chrysanthemums, clematis, craspedia, curcuma, daffodils, dahlias, delphinium, dianthus, freesia, garden roses, gerber, gerberas, hydrangea, hypericum, iris, kale, lemon leaf, lilies, limonium, matsumoto, orchids, peonies, ranunculus, roses, snapdragon, spray roses, statice, stock, succulents, sunflower, tulips, veronica, waxflowers, cabbage roses, sword fern, solidago, mini-sunflower, israeli ruscus, seeded eucalyptus, liatrus, protea, scabiosa pod, delphinium, italian pitt, and lisianthus. The DIY kit, including the unassembled parts of various plants and one or more non-plant materials, may be assembled into the flower product based on the instruction manual. The flower product includes the various plants and the one or more non-plant materials assembled with the various plants. The DIY kit and the instruction manual may be shipped from the supplier, which may be a different company from that of a vendor or seller for vending or selling the DIY kit, to a customer buying the DIY kit.

Another exemplary embodiment of the present disclosure provides a method of vending or selling a do-it-yourself (DIY) kit, or an unassembled kit or self-assembly kit, associated with a flower product, the method including: (1) providing an item representing the flower product on an online platform (e.g., an online or web shop, an online or web store, or a website), (2) receiving a purchase order for the item from the online platform, wherein the purchase order may be submitted through the online platform, (3) acknowledging the purchase order via the online platform or email, (4) preparing the DIY kit and an instruction manual based on the purchase order, and (5) shipping the DIY kit and the instruction manual. The item may include a text associated with the flower product, a video associated with the flower product, and an image (or picture) of the flower product, and the text, the video and the image are presented on the online platform. The DIY kit may include unassembled parts of various plants (including, e.g., one, two or more types of fresh flowers and one, two or more types of flowering plants or leaves) and one or more non-plant materials (including, e.g., a rubber band, a ribbon, a metal wire, a pin, a (floral) tape, a tree branch, a glass orb, a piece of foam, and a container) unassembled with the various plants. The one, two or more types of fresh flowers may include agapanthus, allium, alstroemeria, amaryllis, anemones, anthurium, asclepiad, asters, astilbe, baby's breath, bouvardia, calla lilies, campanulas, carnations, celosia, chrysanthemums, clematis, craspedia, curcuma, daffodils, dahlias, delphinium, dianthus, freesia, garden roses, gerber, gerberas, hydrangea, hypericum, iris, kale, lemon leaf, lilies, limonium, matsumoto, orchids, peonies, ranunculus, roses, snapdragon, spray roses, statice, stock, succulents, sunflower, tulips, veronica, waxflowers, cabbage roses, sword fern, solidago, mini-sunflower, israeli ruscus, seeded eucalyptus, liatrus, protea, scabiosa pod, delphinium, italian pitt, and lisianthus. The DIY kit, including the unassembled parts of various plants and one or more non-plant materials, may be assembled into the flower product based on the instruction manual. The flower product includes the various plants and the one or more non-plant materials assembled with the various plants. The DIY kit and the instruction manual may be shipped from a vendor or seller for vending or selling the DIY kit, to a customer buying the DIY kit.

Another exemplary embodiment of the present disclosure provides a method of vending or selling a do-it-yourself (DIY) kit, or an unassembled kit or self-assembly kit, associated with a flower product, the method including: (1) providing an item representing the flower product on an online platform (e.g., an online or web shop, an online or web store, or a website), (2) receiving a purchase order for the item from the online platform, wherein the purchase order may be submitted through the online platform, (3) acknowledging the purchase order via the online platform or email, (4) sending a request associated with a first unassembled part of the DIY kit for the item to a first supplier based on the purchase order, (5) preparing the first unassembled part of the DIY kit based on the request, (6) shipping the first unassembled part of the DIY kit from the first supplier to a customer, (7) preparing a second unassembled part of the DIY kit and an instruction manual for the item based on the purchase order, and (8) shipping the second unassembled part of the DIY kit and the instruction manual from a second supplier, different from the first supplier, to the customer, wherein the second supplier may be a vendor or seller for vending or selling the DIY kit. The item may include a text associated with the flower product, a video associated with the flower product, and an image (or picture) of the flower product, and the text, the video and the image are presented on the online platform. The first unassembled part of the DIY kit may include various plants (including, e.g., one, two or more types of fresh flowers and one, two or more types of flowering plants or leaves), and the second unassembled part of the DIY kit may include one or more non-plant materials (including, e.g., a rubber band, a ribbon, a metal wire, a pin, a (floral) tape, a tree branch, a glass orb, a piece of foam, and a container). The one, two or more types of fresh flowers may include agapanthus, allium, alstroemeria, amaryllis, anemones, anthurium, asclepiad, asters, astilbe, baby's breath, bouvardia, calla lilies, campanulas, carnations, celosia, chrysanthemums, clematis, craspedia, curcuma, daffodils, dahlias, delphinium, dianthus, freesia, garden roses, gerber, gerberas, hydrangea, hypericum, iris, kale, lemon leaf, lilies, limonium, matsumoto, orchids, peonies, ranunculus, roses, snapdragon, spray roses, statice, stock, succulents, sunflower, tulips, veronica, waxflowers, cabbage roses, sword fern, solidago, mini-sunflower, israeli ruscus, seeded eucalyptus, liatrus, protea, scabiosa pod, delphinium, italian pitt, and lisianthus. The DIY kit, including the first and second unassembled parts, may be assembled into the flower product based on the instruction manual. The flower product may include the various plants and the one or more non-plant materials assembled with the various plants.

These, as well as other components, steps, features, benefits, and advantages of the present disclosure, will now become clear from a review of the following detailed description of illustrative embodiments, the accompanying drawings, and the claims.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same reference number or reference indicator appears in different drawings, it may refer to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure. In the drawings:

FIG. 1 is a system diagram illustrating a network system for vending do-it-yourself (DIY) kits (or self-assembly kits) associated with flower products;

FIG. 2A shows an online platform appearing on a browser installed in a device;

FIG. 2B shows a shopping cart of an online platform appearing on a browser installed in a device according to an embodiment of the present invention;

FIG. 3 shows an instruction manual and an unassembled kit associated with a flower product to be placed in a box according to an embodiment of the present invention;

FIGS. 4A, 4B and 4C show an example of an instruction manual according to an embodiment of the present invention;

FIG. 5 shows a shopping cart of an online platform appearing on a browser installed in a device according to an embodiment of the present invention;

FIG. 6 shows an instruction manual and an unassembled kit associated with a flower product to be placed in a box according to an embodiment of the present invention;

FIGS. 7A and 7B show an example of an instruction manual according to an embodiment of the present invention;

FIG. 8 is a flow chart illustrating a method of vending an unassembled kit for a customer to assemble the unassembled kit for a flower product according to an embodiment of the present invention;

FIG. 9 is a flow chart illustrating a method of vending an unassembled kit for a customer to assemble the unassembled kit for a flower product according to an embodiment of the present invention;

FIG. 10A shows a floral arrangement holder according to an embodiment of the present invention;

FIG. 10B shows a cross-sectional view of a floral arrangement holder according to an embodiment of the present invention; and

FIGS. 11A and 11B show an online platform appearing on a browser installed in a device.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

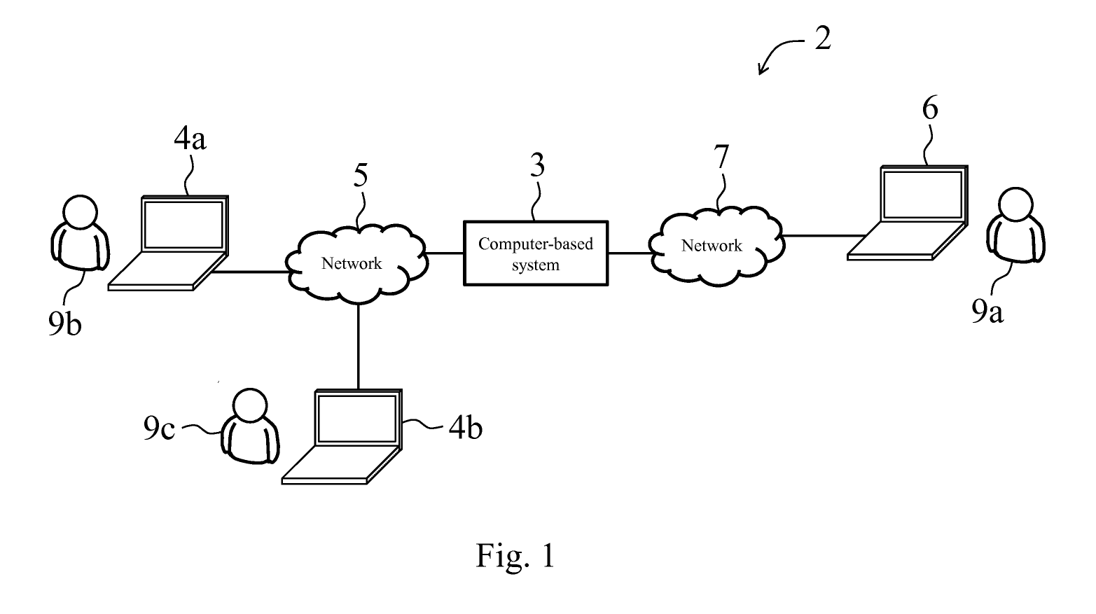

FIG. 1 depicts an exemplary embodiment of a network system 2, upon which unassembled parts of a do-it-yourself (DIY), unassembled, or self-assembly kit associated with a flower product may be vended or sold to a customer 9b or 9c to assemble the unassembled parts of the kit into the flower product. It is to be understood that the network system 2 is merely exemplary of one such embodiment and it will be recognized that alternative systems and structures may be used to implement the method as disclosed herein.

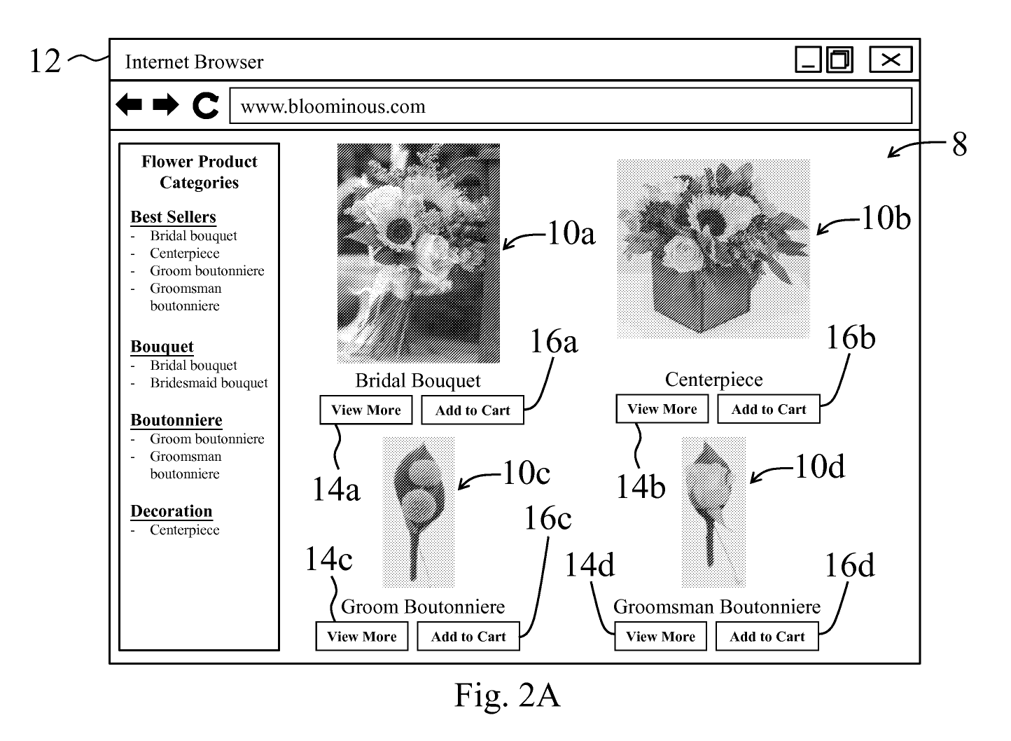

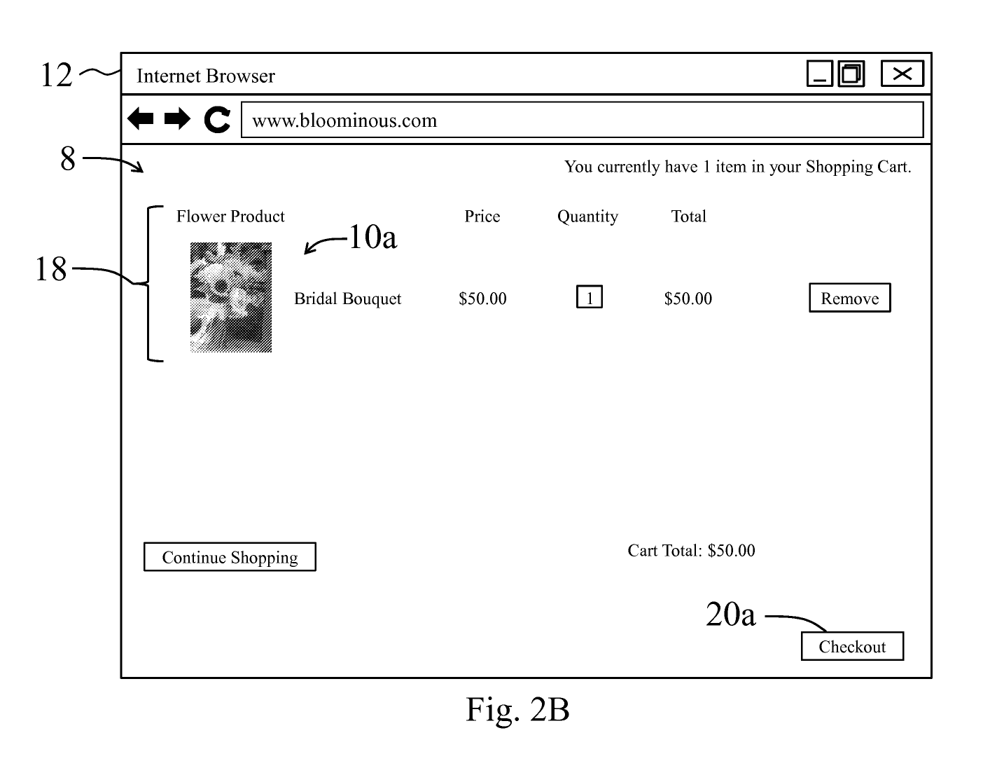

Referring to FIG. 1, the network system 2 includes (1) a computer-based system 3 (including, e.g., at least one (cloud or web) server), (2) a first customer device 4a with an operating system (e.g., Windows, Mac OS, Android, or iOS) communicatively connected to the computer-based system 3 through a communications network 5 such as the Internet, (3) a second customer device 4b with an operating system (e.g., Windows, Mac OS, Android, or iOS) communicatively connected to the computer-based system 3 through the communications network 5, and (4) a vendor device 6 with an operating system (e.g., Windows, Mac OS, Android, or iOS) communicatively connected to the computer-based system 3 through a communications network 7 such as the Internet. Each of the devices 4a, 4b and 6 may be a computer (e.g., a desktop computer, a laptop computer, or a tablet computer) or a smart phone. In addition, an online platform 8 (e.g., a shopping website, an online or web store, or an online shopping store) shown in FIG. 2A is hosted on the computer-based system 3, accessible via the network 5 or 7.

Referring to FIGS. 1 and 2A, a vendor (or seller) 9a uses the device 6 to access the online platform 8 and create or provide multiple items (hereinafter the “items TS”) on the online platform 8 through the network 7 such that the items TS may be viewed on the online platform 8 by customers, such as 9b and 9c. The items TS may include four items 10a, 10b, 10c and 10d shown in FIG. 2A. Also, the items TS may include an item of an aisle decoration, an item of a crown, an item of a cocktail arrangement, an item of a reception table arrangement, an item of a flower basket, an item of a corsage, and/or an item of groomsman boutonniere. Each of the items TS represents a flower product, which may include (1) various plants (including, e.g., one, two or more types of fresh flowers, one, two or more types of flowering plants or leaves, and one or more stems with leaves but without flowers), (2) one or more non-plant materials assembled with or combined with the various plants, including, e.g., one or more of the following items: one or more rubber bands, one or more ribbons (such as a white ribbon and/or a red ribbon), one or more lace ribbons, one or more pins (such as large head pins, corsage pins, or pearl pins), one or more ties, a metal wire, a (floral) tape, one or more pieces of foam, a tree branch, and a glass orb, and (3) a container, if needed, holding or carrying the various plants and/or the one or more non-plant materials. The container may be a vase, a basket or a wooden box. The one, two or more types of fresh flowers may include one or more of agapanthus, allium, alstroemeria, amaryllis, anemones, anthurium, asclepiad, asters, astilbe, baby's breath, bouvardia, calla lilies, campanulas, carnations, celosia, chrysanthemums, clematis, craspedia, curcuma, daffodils, dahlias, delphinium, dianthus, freesia, garden roses, gerber, gerberas, hydrangea, hypericum, iris, kale, lemon leaf, lilies, limonium, matsumoto, orchids, peonies, ranunculus, roses, snapdragon, spray roses, statice, stock, succulents, sunflower, tulips, veronica, waxflowers, cabbage roses, sword fern, solidago, mini-sunflower, israeli ruscus, seeded eucalyptus, liatrus, protea, scabiosa pod, delphinium, italian pitt, and lisianthus). The one, two or more types of flowering plants or leaves may include one or more of Ruscus greens, lemon leaves, goldenrods, craspedia balls, alstroemeria, and hypericum. A text, a video and an image (or a picture) for each of the items TS associated with the corresponding flower product may be viewed on the online platform 8 via the networks 5 and 7.

For example, the item 10a represents a bridal bouquet (hereinafter the “flower product FB”), which includes (1) arrangements of fresh flowers (such as sunflowers and yellow roses), flowering plants (such as solidago (commonly called goldenrods), craspedia balls and hypericum) and stems of leaves (such as Ruscus greens) bound together with one or more rubber bands, (2) a white ribbon and a lace ribbon tied onto the arrangements, and (3) one or more pins securing the write ribbon. The item 10b represents a centerpiece (hereinafter the “flower product FC”), which includes (1) a wooden box, (2) a floral foam, soaking in water, in the wooden box, (3) multiple stems of lemon leaves inserted or set into the floral foam, (4) three types of fresh flowers (i.e., sunflowers, yellow roses, and red spray roses) inserted or set into the floral foam, and (5) three types of flowering plants (i.e., solidago, hypericum and alstroemeria) inserted or set into the floral foam. The item 10c represents a groom boutonniere (i.e., a kind of flower product), which includes (1) a stem of craspedia balls and a stem of a leaf bound together with floral tape, (2) a metal wire with a curved shape inserted into the stem of the leaf, and (3) a pin inserted into the floral tape. Each of the items TS containing the four items 10a-10d may include a text associated with the corresponding flower product and an image (or picture) of the corresponding flower product, and the texts and the images are presented on the online platform 8.

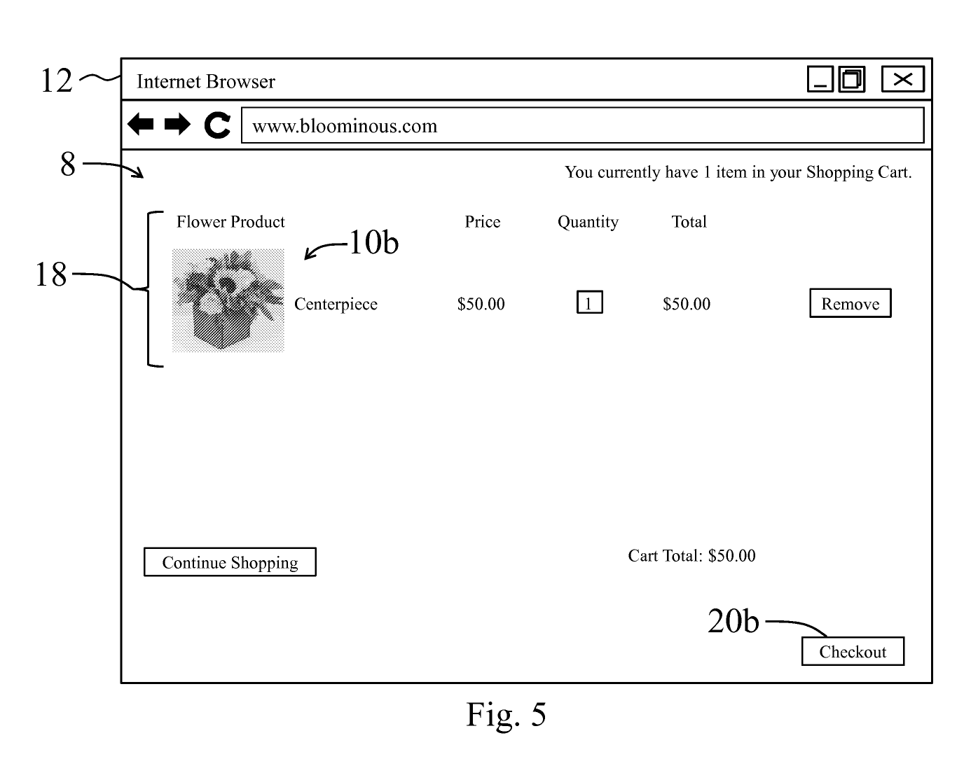

The customers may use computers (such as desktop computers, laptop computers, or tablet computers) or smart phones to access or view the online platform 8 and order one or more of the items TS listed on the online platform 8 through the network 5. Here the customers include (1) the customer 9b, who uses a browser (e.g., a browser 12 shown in FIG. 2A) installed on the device 4a to access or view the online platform 8 and order one or more of the items 10a, 10b, 10c and 10d listed on the online platform 8 through the network 5, and (2) the customer 9c, who uses a browser (e.g., the browser 12 shown in FIG. 2A) installed on the device 4b to access or view the online platform 8 and order one or more of the items 10a, 10b, 10c and 10d listed on the online platform 8 through the network 5. Alternatively, the customer 9b or 9c may use an application program, downloaded from a digital distribution platform (or an online electronics and digital media store) to be installed on the device 4a or 4b, to access or view the online platform 8 and order one or more of the items 10a, 10b, 10c and 10d listed on the online platform 8 through the network 5. The customers 9b and 9c may click any one of “View More” buttons 14a, 14b, 14c and 14d to view more information about the corresponding item 10a, 10b, 10c or 10d, including details of the corresponding flower product (containing, e.g., an image (or picture), size, and weight of each piece of the corresponding unassembled kit to be assembled by a customer), video instruction, and suggestions. In addition, the customers 9b and 9c may add any one of the items 10a-10d into a shopping cart 18 of the online platform 8, shown in FIG. 2B or 5, by clicking the corresponding “Add to Cart” button 16a, 16b, 16c or 16d.

### For First Example

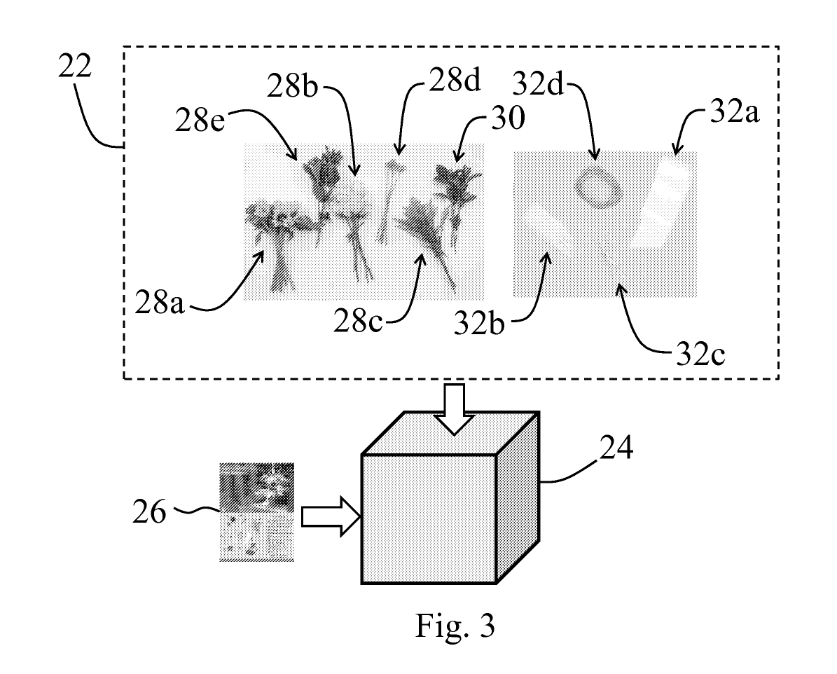

Referring to FIGS. 2A and 2B, the customer 9b may add the item 10a associated with the flower product FB into the shopping cart 18 of the online platform 8 by clicking the “Add to Cart” button 16a. After the item 10a is added into the shopping cart 18 of the online platform 8, the customer 9b may start a checkout process by clicking a “Checkout” button 20a to pay for the item 10a by a credit card or by account transferring and to submit or send a first purchase order for the item 10a to the vendor 9a through the online platform 8. The vendor 9a receives the first purchase order for the item 10a from the online platform 8 and thereafter may acknowledge the first purchase order via the online platform 8 or email. After receiving the first purchase order, the vendor 9a may send or submit a first request (or order) associated with an unassembled kit 22 (or a do-it-yourself (DIY) or self-assembly kit) for the item 10a, as shown in FIG. 3, to a supplier by, e.g., telephone, fax, email, text messaging, or other electronic means. The supplier, which may be a fresh flower broker, a wholesaler, a farmer who cultivates or owns a flower farm, or a different company from that of the vendor 9a, cooperates with the vendor 9a to supply the unassembled kit 22 for the item 10a to the customer 9b or his or her friends or relatives. Here the unassembled kit 22 is associated with the flower product FB. Referring to FIG. 3, after receiving (or accepting) the first request, the supplier prepares the unassembled kit 22 for the item 10a and places in a box 24 (e.g., a delivery or shipping carton) the unassembled kit 22 for the item 10a and an instruction manual 26 of instructing a person (e.g., the customer 9b) to assemble the unassembled kit 22 into the flower product FB. The unassembled kit 22 and the instruction manual 26 placed in the box 24 are shipped from the supplier to the customer 9b (or his or her friends or relatives) to assemble the unassembled kit 22 into the flower product FB based on instructions listed on the instruction manual 26.

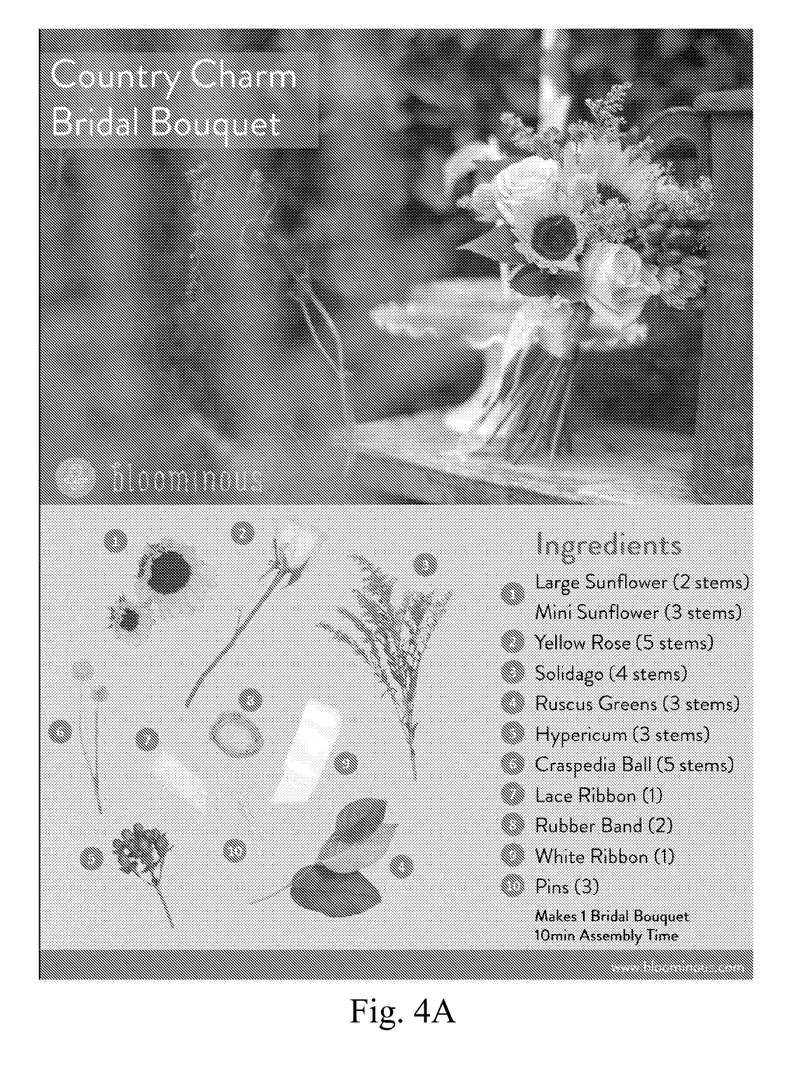

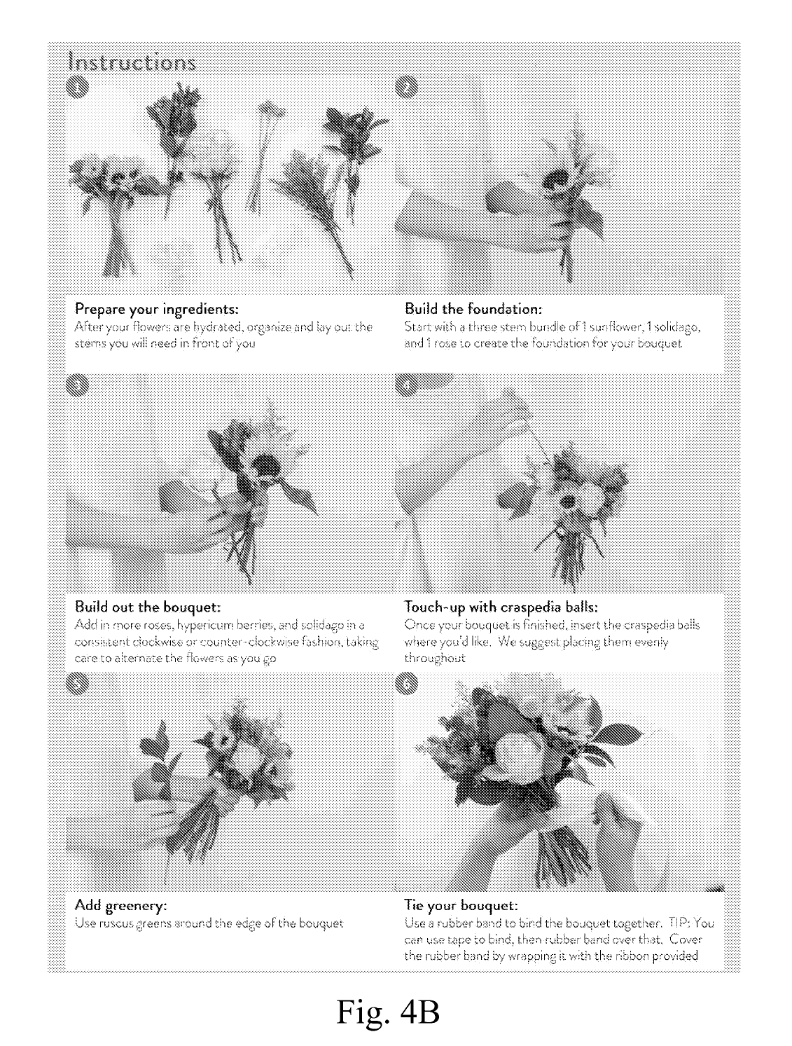

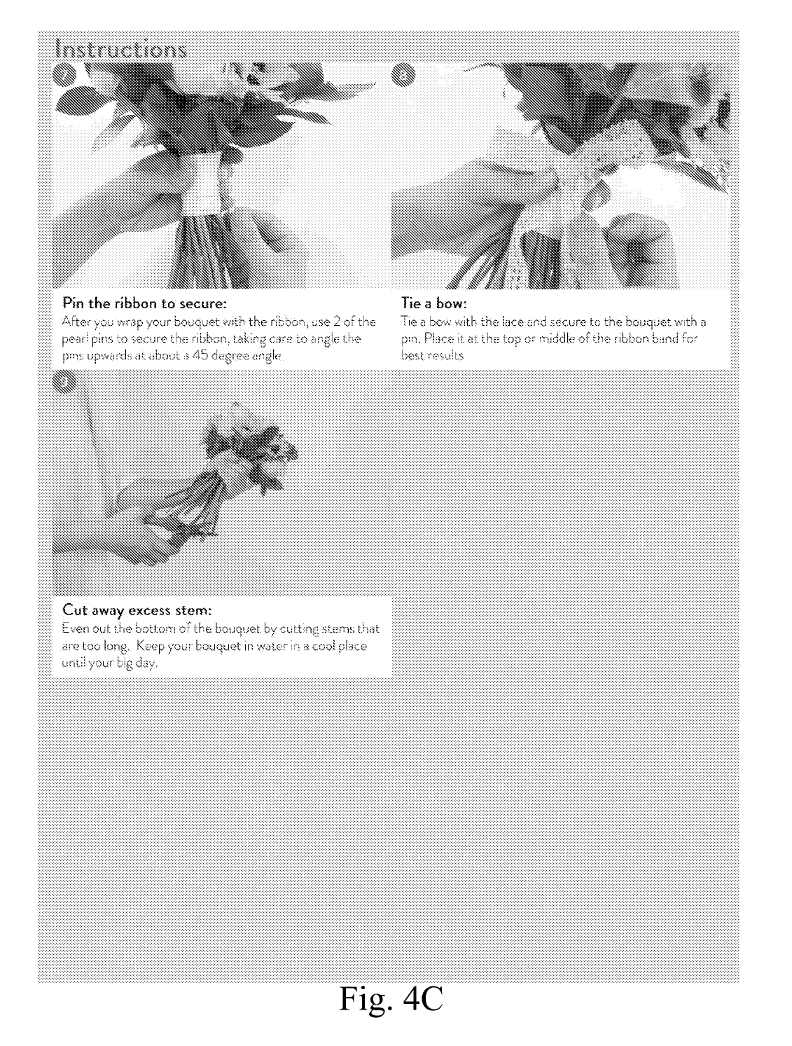

The unassembled kit 22 for the item 10a may include (1) a first unassembled part of various plants, including fresh flowers 28a and 28b, flowering plants 28c-28e, and stems of leaves 30, and (2) a second unassembled part of various non-plant materials, including a white ribbon 32a, a lace ribbon 32b, pins 32c, rubber bands 32d, and a floral tape (optional, not shown in FIG. 3), unassembled with, or not combined with, the first unassembled part of various plants. The first unassembled part of various plants may be preprocessed (e.g., precut) to have a volume or size less than that of the box 24 and portioned into groups based on their types. After the customer 9b receives the unassembled kit 22 and the instruction manual 26 placed in the box 24, the first unassembled part of various plants, including sunflowers 28a, yellow roses 28b, goldenrods 28c, craspedia balls 28d, hypericum 28e, and stems of Ruscus greens 30, may be assembled step by step with the second unassembled part of various non-plant materials, including the white ribbon 32a, the lace ribbon 32b, the pins 32c, the rubber bands 32d, and the floral tape (optional), based on the instructions listed on the instruction manual 26. The instruction manual 26, recorded in a CD-ROM or a data storage device or made of recycled paper, for example, is configured to instruct a person (e.g., the customer 9b) to assemble the first unassembled part of various plants and the second unassembled part of various non-plant materials into the flower product FB. Alternatively, the instruction manual 26 may be obtained or downloaded from the online platform 8. FIGS. 4A, 4B and 4C show an example of the instruction manual 26.

Referring to FIGS. 4B and 4C, the instruction manual 26 instructs a person to assemble the unassembled kit 22, following steps in sequence mentioned as below. Step 1 includes preparing your ingredients: after your flowers are hydrated, organize and lay out the stems you will need in front of you. Step 2 includes building the foundation: start with a three stem bundle of 1 sunflower, 1 solidago, and 1 rose to create the foundation for your bouquet. Step 3 includes building out the bouquet: add in more roses, hypericum berries, and solidago in a consistent clockwise or counter-clockwise fashion, taking care to alternate the flowers as you go. Step 4 includes touching up with craspedia balls: once your bouquet is finished, insert the craspedia balls where you'd like; we suggest placing them evenly throughout. Step 5 includes adding greenery: use ruscus greens around the edge of the bouquet. Step 6 includes tying your bouquet: use a rubber band to bind the bouquet together, and then cover the rubber band by wrapping it with the ribbon provided; you can use tape to bind, then rubber band over that. Step 7 includes pinning the ribbon to secure: after you wrap your bouquet with the ribbon, use 2 of the pearl pins to secure the ribbon, taking care to angle the pins upwards at about a 45 degree angle. Step 8 includes tying a bow: tie a bow with the lace and secure to the bouquet with a pin; place it at the top or middle of the ribbon band for best results. Step 9 includes cutting away excess stem: even out the bottom of the bouquet by cutting stems that are too long; keep your bouquet in water in a cool place until your big day.

In an alternative embodiment, after the vendor 9a receives the first purchase order, the first unassembled part of various plants may be prepared by the supplier to be shipped from the supplier to the vendor 9a, and then placed with the second unassembled part of various non-plant materials in the box 24 by the vendor 9a to be shipped from the vendor 9a to the customer 9b or his or her friends or relatives. In an alternative embodiment, the unassembled kit 22 may be placed in multiple delivery or shipping boxes, a first one of which contains the first unassembled part of various plants and a second one of which contains the second unassembled part of various non-plant materials, to be shipped from the vendor 9a or the supplier to the customer 9b (or his or her friends or relatives). In an alternative embodiment, regarding to the unassembled kit 22, the first unassembled part of various plants may be placed in a first delivery or shipping box to be shipped from the supplier to the customer 9b (or his or her friends or relatives), and the second unassembled part of various non-plant materials and the instruction manual 26 may be placed in a second delivery or shipping box to be shipped from the vendor 9a to the customer 9b (or his or her friends or relatives).

Upon receiving the unassembled kit 22 from the supplier and/or the vendor 9a, the customer 9b (or his or her friends or relatives) may assemble the unassembled kit 22 into the flower product FB based on the instruction manual 26, that is, the customer 9b may assemble the fresh flowers 28a and 28b, the flowering plants 28c-28e, and the stems of leaves 30 with the non-plant materials 32a-32d according to instructions listed on the instruction manual 26. After the unassembled kit 22 is assembled into the flower product FB, the flower product FB includes (1) arrangements of the fresh flowers 28a and 28b, the flowering plants 28c-28e, and the stems of leaves 30 bound together with one or more rubber bands 32d, (2) the white ribbon 32a and the lace ribbon 32b tied onto the arrangements, and (3) one or more pins 32c secured to the white ribbon 32a.

### For Second Example

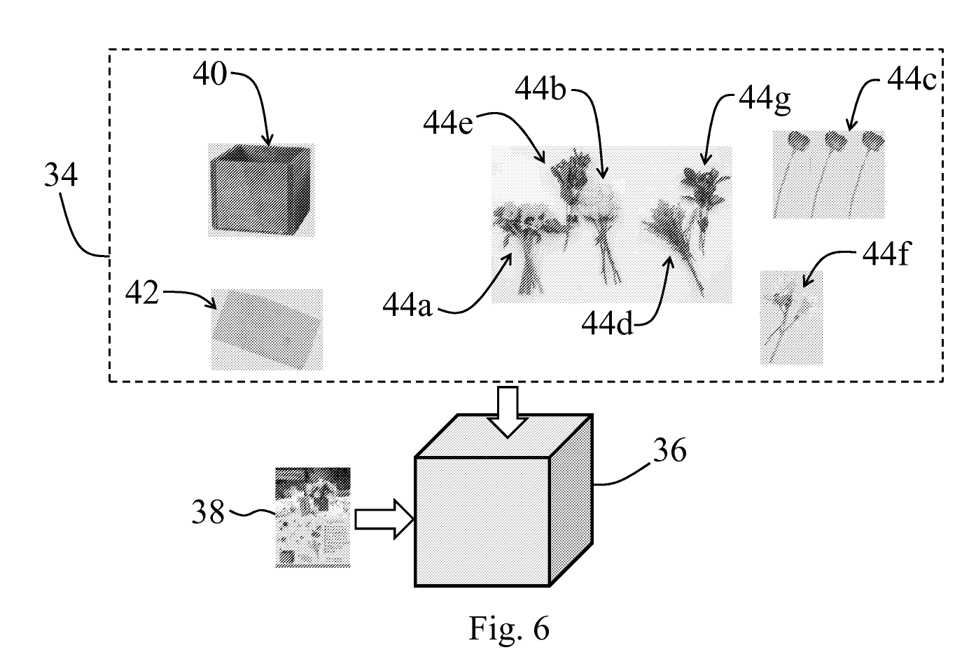

Referring to FIGS. 2A and 5, the customer 9c adds the item 10b associated with the flower product FC into the shopping cart 18 of the online platform 8 by clicking the “Add to Cart” button 16b and starts a checkout process by clicking a “Checkout” button 20b to pay for the item 10b by a credit card or by account transferring and to submit or send a second purchase order for the item 10b to the vendor 9a through the online platform 8, for example. The vendor 9a receives the second purchase order for the item 10b from the online platform 8 and thereafter may acknowledge the second purchase order via the online platform 8 or email. After receiving the second purchase order, the vendor 9a may send or submit a second request (or order) associated with an unassembled kit 34 (or a do-it-yourself (DIY) or self-assembly kit) for the item 10b, as shown in FIG. 6, to the above-mentioned supplier by, e.g., telephone, fax, email, text messaging, or other electronic means. The supplier cooperates with the vendor 9a to supply the unassembled kit 34 for the item 10b to the customer 9c or his or her friends or relatives. Here the unassembled kit 34 is associated with the flower product FC. Referring to FIG. 6, after receiving (or accepting) the second request, the supplier prepares the unassembled kit 34 for the item 10b and places in a box 36 (e.g., a delivery or shipping carton) the unassembled kit 34 for the item 10b and an instruction manual 38 of instructing a person (e.g., the customer 9c) to assemble the unassembled kit 34 into the flower product FC. The unassembled kit 34 and the instruction manual 38 placed in the box 36 are shipped from the supplier to the customer 9c (or his or her friends or relatives) to assemble the unassembled kit 34 into the flower product FC based on instructions listed on the instruction manual 38.

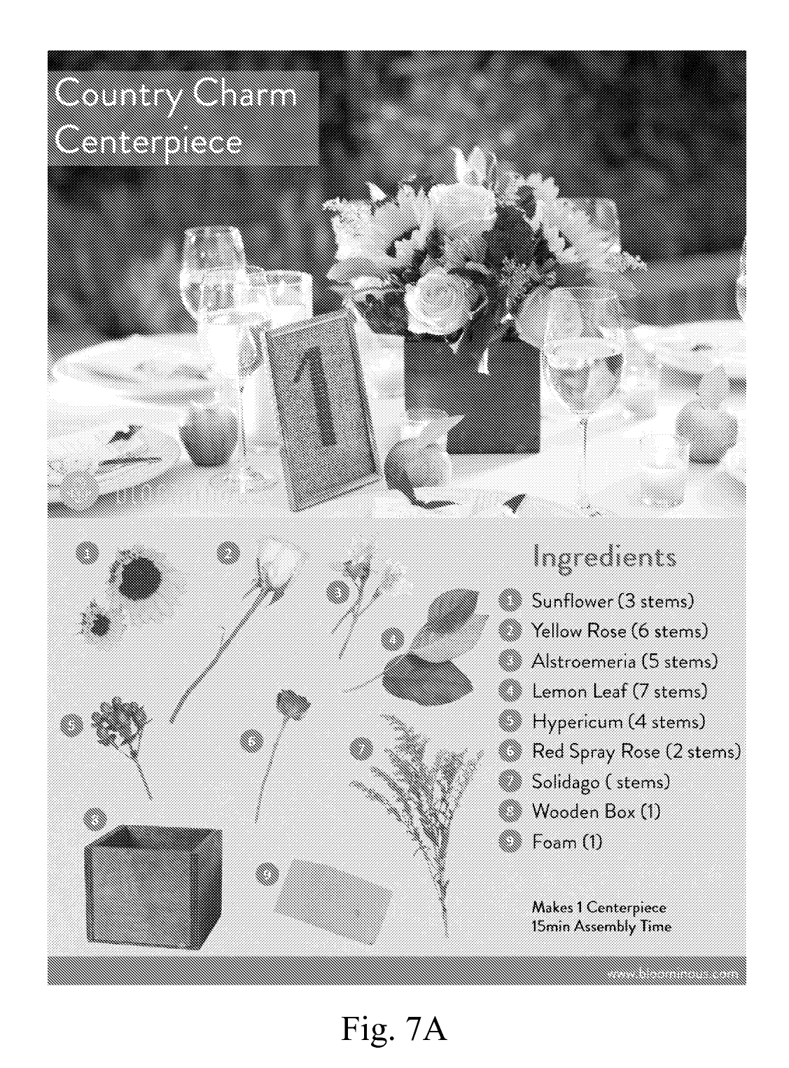

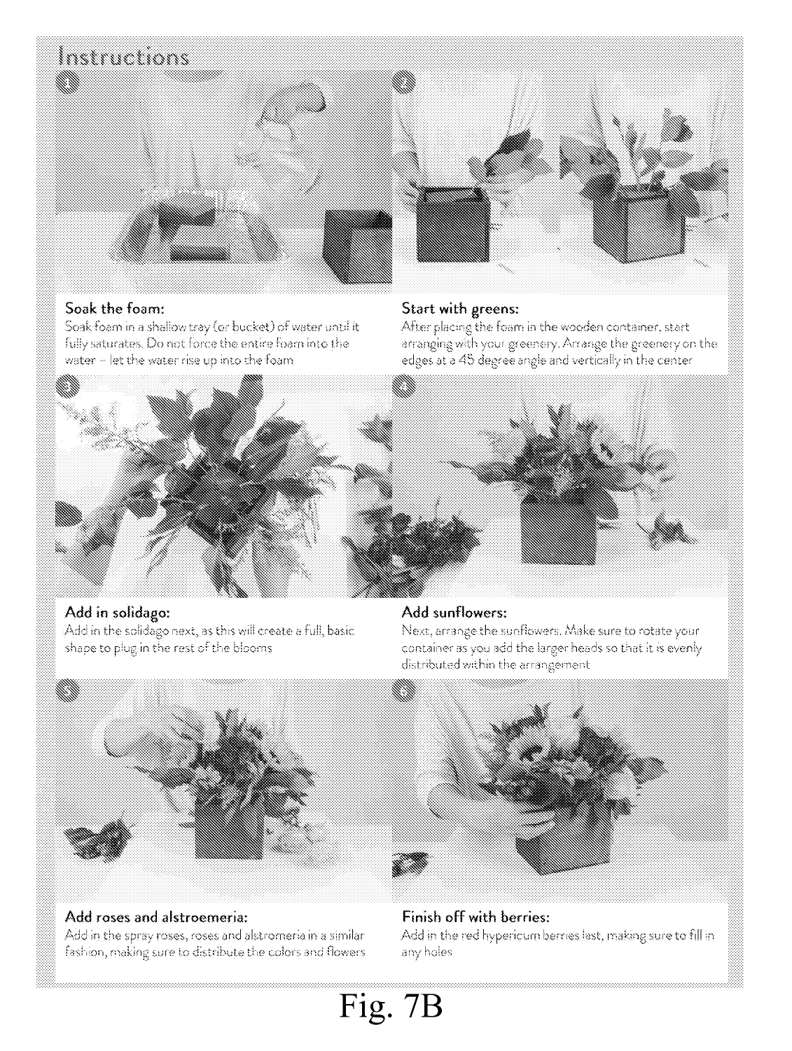

The unassembled kit 34 for the item 10b may include (1) a wooden box 40 (i.e., a container), (2) a floral foam 42 (i.e., a non-plant material), and (3) various plants, including fresh flowers 44a-44c, flowering plants 44d-44f, and stems of lemon leaves 44g, not inserted or set into, or unassembled with, the floral foam 42. The various plants of the unassembled kit 34 may be preprocessed (e.g., precut) to have a volume or size less than that of the box 36 and portioned into groups based on their types. After the customer 9c receives the unassembled kit 34 and the instruction manual 38 placed in the box 36, a first unassembled part of various plants, including sunflowers 44a, yellow roses 44b, red spray roses 44c, goldenrods 44d, hypericum 44e, alstroemeria 44f, and the stems of lemon leaves 44g, may be assembled step by step with a second unassembled part of various non-plant materials, i.e., the floral foam 42 and wooden box 40, based on the instructions listed on the instruction manual 38. The instruction manual 38, recorded in a CD-ROM or a data storage device or made of recycled paper, for example, is configured to instruct a person (e.g., the customer 9c) to assemble the unassembled kit 34 of the wooden box 40, the floral foam 42 and the various plants into the flower product FC. Alternatively, the instruction manual 38 may be obtained or downloaded from the online platform 8. FIGS. 7A and 7B show an example of the instruction manual 38.

Referring to FIG. 7B, the instruction manual 38 instructs a person to assemble the unassembled kit 34, following steps in sequence mentioned as below. Step 1 includes soaking the foam: soak foam in a shallow tray (or bucket) of water until it fully saturates; do not force the entire foam into the water—let the water rise up into the foam. Step 2 includes starting with greens: after placing the foam in the wooden container, start arranging with your greenery; arrange the greenery on the edges at a 45 degree angle and vertically in the center. Step 3 includes adding in solidago: add in the solidago next, as this will create a full, basic shape to plug in the rest of the blooms. Step 4 includes adding sunflowers: arrange the sunflowers; make sure to rotate your container as you add the larger heads so that it is evenly distributed within the arrangement. Step 5 includes adding roses and alstroemeria: add in the spray roses, roses and alstromeria in a similar fashion, making sure to distribute the colors and flowers. Step 6 includes finishing off with berries: add in the red hypericum berries last, making sure to fill in any holes.

In an alternative embodiment, after the vendor 9a receives the second purchase order, the first unassembled part of various plants may be prepared by the supplier to be shipped from the supplier to the vendor 9a, and then placed with the second unassembled part of various non-plant materials in the box 36 by the vendor 9a to be shipped from the vendor 9a to the customer 9c or his or her friends or relatives. In an alternative embodiment, the unassembled kit 34 may be placed in multiple delivery or shipping boxes, a first one of which contains the first unassembled part of various plants and a second one of which contains the second unassembled part of various non-plant materials, to be shipped from the vendor 9a or the supplier to the customer 9c (or his or her friends or relatives). In an alternative embodiment, regarding to the unassembled kit 34, the first unassembled part of various plants may be placed in a first delivery or shipping box to be shipped from the supplier to the customer 9c (or his or her friends or relatives), and the second unassembled part of various non-plant materials and the instruction manual 38 may be placed in a second delivery or shipping box to be shipped from the vendor 9a to the customer 9c (or his or her friends or relatives).

Upon receiving the unassembled kit 34 from the supplier and/or the vendor 9a, the customer 9c (or his or her friends or relatives) may assemble the unassembled kit 34 into the flower product FC based on the instruction manual 38, that is, the customer 9c may soak the floral foam 42 in water, place the soaked floral foam 42 into the wooden box 40, and insert or set the plants 44a-44g into the floral foam 42 according to instructions listed on the instruction manual 38. After the unassembled kit 34 is assembled into the flower product FC, the flower product FC includes (1) the wooden box 40, (2) the floral foam 42, soaking in water, in the wooden box 40, (3) the fresh flowers 44a-44c inserted or set into the floral foam 42, (4) the flowering plants 44d-44f inserted or set into the floral foam 42, and (5) the stems of lemon leaves 44g inserted or set into the floral foam 42.

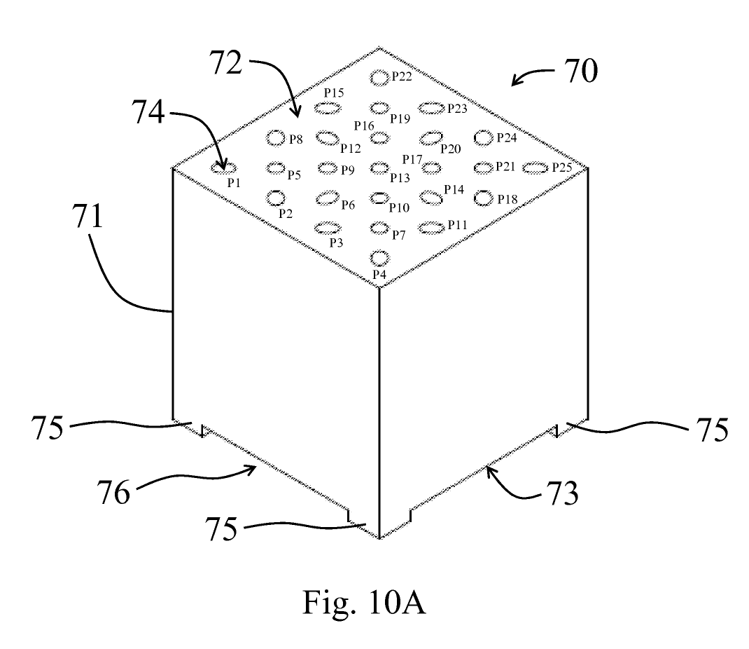

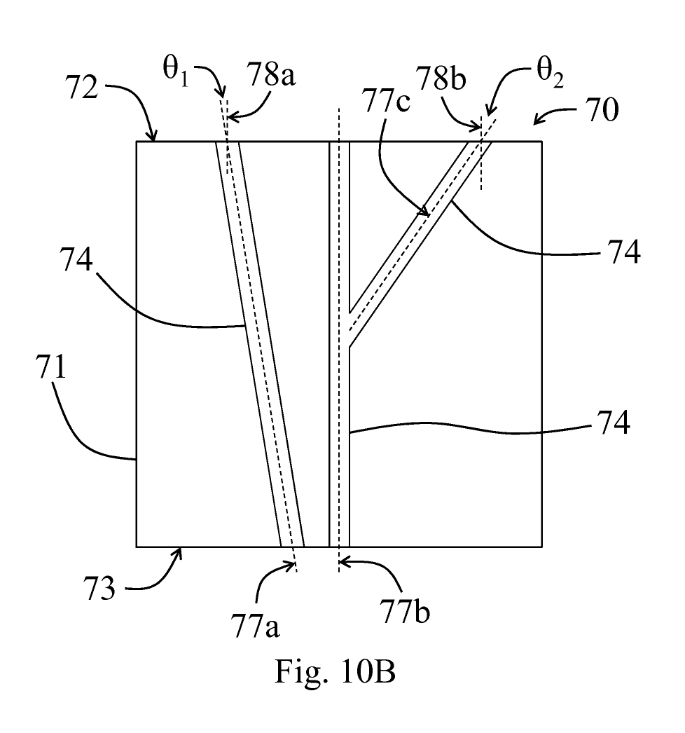

Alternatively, the floral foam 42 may be replaced with a floral arrangement holder 70 shown in FIG. 10A. The holder 70, provided with multiple preformed holes 74 for receiving the plants 44a-44g of the unassembled kit 34, may be fabricated by one or more processes including a three-dimensional (3D) printing process and/or a laser drilling process and may include a body 71 having a first surface 72 as an floral arrangement plane and a second surface 73 opposite to the first surface 72. The vertical distance between the first and second surfaces 72 and 73 may greater than 5 centimeters, and more preferably greater than 8 centimeters. The preformed holes 74 may extend from the first surface 72 into or through the body 71, which allow the plants 44a-44g of the unassembled kit 34 to be inserted therein. Each of the preformed holes 74 may be a blind hole, a branching hole, or a through hole, and alternatively, the preformed holes 74 may be a combination of blind holes, branching holes and through holes. Each preformed hole 74 may be labeled with a symbol (e.g., a corresponding one of symbols P1 through P25) or may show different color so that the customer 9c can follow the instruction, which illustrates each specific one of the plants 44a-44f to be inserted into a corresponding specific one of the preformed holes 74 labeled with a corresponding specific one of the symbols or colors, to insert or set said each specific one of the plants 44a-44g into the corresponding specific one of the preformed holes 74 labeled with the corresponding specific one of the symbols or colors. The material of the body 71 may be plastic, foam, glass, metal, or ceramic. In addition, the holder 70 may have four supporting parts 75 downwards projecting from the second surface 73 of the body 71 with a height between 0.5 and 2 centimeters. The body 71 may be supported by the supporting parts 75 to form a free or empty space 76 under the second surface 73 of the body 71 and between neighboring two of the supporting parts 75.

FIG. 10B shows a cross-sectional view cut through the three preformed holes 74 labeled with the symbols P12, P13 and P14 shown in FIG. 10A. The preformed hole 74 labeled with the symbol P12, which may be a through hole passing through the body 71 from the first surface 72 to the second surface 73, may have an axis 77a not perpendicular, but oblique, to the first and second surfaces 72 and 73. An acute angle θ₁ between the axis 77a and a straight line 78a vertical to the first surface 72 may range from 1 degree to 60 degrees, such as from 10 degrees to 45 degrees, based on the design for the flower product FC. The hole 74 labeled with the symbol P13, which may be a through hole passing through the body 71 from the first surface 72 to the second surface 73, may have an axis 77b substantially perpendicular to the first and second surfaces 72 and 73. The hole 74 labeled with the symbol P14, which may be a branching hole partially passing through the body 71 and having an inner end connecting with the hole 74 labeled with the symbol P13, may have an axis 77c not perpendicular, but oblique, to the first surface 72. An acute angle θ₂ between the axis 77c and a straight line 78b vertical to the first surface 72 may range from 1 degree to 60 degrees, such as from 10 degrees to 45 degrees, based on the design for the flower product FC. Alternatively, a bland hole, partially passing through the body 71 and having a closed inner end, may be formed with an axis not perpendicular, but oblique, to the first surface 72 at an acute angle therebetween ranging from 1 degree to 60 degrees, such as from 10 degrees to 45 degrees, based on the design for the flower product FC. Alternatively, a bland hole, partially passing through the body 71 and having a closed inner end, may be formed with an axis substantially perpendicular to the first surface 72. Accordingly, referring to FIGS. 6, 10A and 10B, based on instructions listed on the instruction manual 38, the unassembled kit 34 including the holder 70 (i.e., a non-plant material), the wooden box 40 and the plants 44a-44g may be assembled into the flower product FC. After the holder 70 is placed into the wooden box 40, water is poured into the wooden box 40 and may flow into the preformed holes 74 from their bottom ends through the space 76 or from their top ends so that the plants 44a-44g inserted or set into the holes 74 can suck up water in the preformed holes 74.

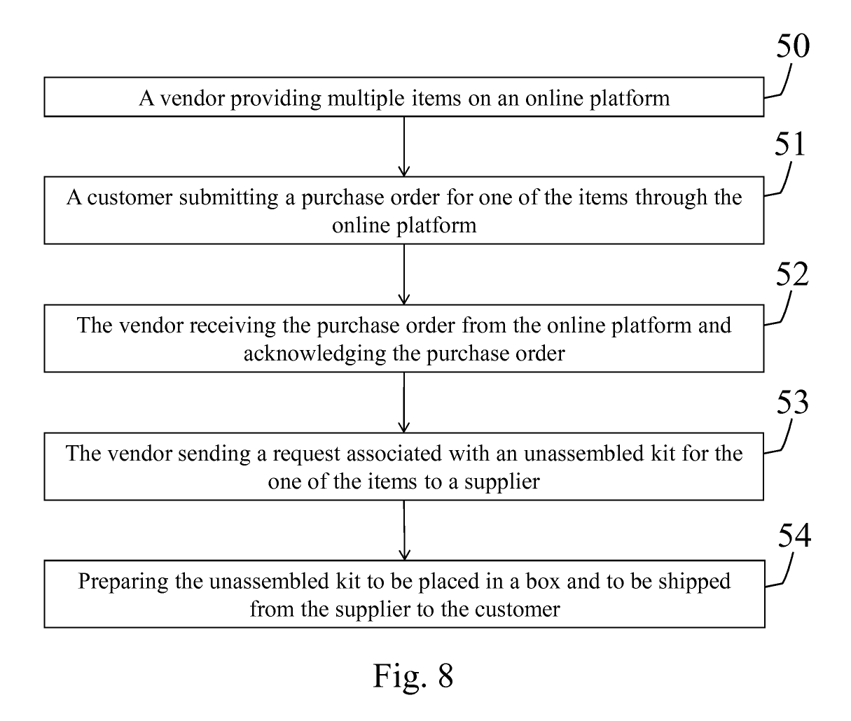

According to the illustration of FIGS. 1, 2A, 2B and 3-7, the invention provides a method of vending or selling an unassembled kit for a customer to assemble the unassembled kit into a flower product. FIG. 8 is a flow chart illustrating a first embodiment of the method of vending or selling the unassembled kit for the customer to assemble the unassembled kit into the flower product. Referring to FIG. 8, in step 50, the vendor 9a may operate the device 6 to provide or present the items TS (including, e.g., the items 10a, 10b, 10c and 10d) on the online platform 8. Next, in step 51, a customer (e.g., the customer 9b or 9c) may operate a software (e.g., the browser 12 or the application program downloaded from the digital distribution platform) installed on a device, such as the device 4a or 4b, to submit a purchase order for one of the items TS, such as the above-mentioned first or second purchase order, to the vendor 9 through the online platform 8. In step 52, after the customer submits the purchase order to the vendor 9a through the online platform 8, the vendor 9a receives the purchase order from the online platform 8 and thereafter may acknowledge the purchase order via the online platform 8 or email. In step 53, after receiving the purchase order, the vendor 9a may submit or send a request (or order) associated with an unassembled, do-it-yourself (DIY), or self-assembly kit (e.g., the unassembled one 22 or 34) for the one of the items TS, such as the above-mentioned first or second request, to the supplier.

In step 54, after receiving or accepting the request, the supplier prepares the unassembled kit for the one of the items TS to be placed in a box (e.g., the shipping box 24 or 36) and to be shipped from the supplier (e.g., a fresh flower broker, a wholesaler, or a farmer) to the customer or his or her friends or relatives according to an address listed on the request. The one of the items TS may be the item 10a or 10b. The unassembled kit includes unassembled parts of various plants (including, e.g., one, two or more types of fresh flowers, one, two or more types of flowering plants, and/or stems of leaves) and various non-plant materials (including, e.g., one or more of a rubber band, a ribbon, a metal wire, a pin, a (floral) tape, a tree branch, a glass orb, a piece of foam, and a container) unassembled with the various plants. The one, two or more types of fresh flowers may include agapanthus, allium, alstroemeria, amaryllis, anemones, anthurium, asclepiad, asters, astilbe, baby's breath, bouvardia, calla lilies, campanulas, carnations, celosia, chrysanthemums, clematis, craspedia, curcuma, daffodils, dahlias, delphinium, dianthus, freesia, garden roses, gerber, gerberas, hydrangea, hypericum, iris, kale, lemon leaf, lilies, limonium, matsumoto, orchids, peonies, ranunculus, roses, snapdragon, spray roses, statice, stock, succulents, sunflower, tulips, veronica, waxflowers, cabbage roses, sword fern, solidago, mini-sunflower, israeli ruscus, seeded eucalyptus, liatrus, protea, scabiosa pod, delphinium, italian pitt, and lisianthus. The unassembled part of various plants may be preprocessed (e.g., precut) to have a volume or size less than that of the box and portioned into groups based on their types. An instruction manual, shipped with the unassembled kit or downloaded from the online platform 8, is configured to instruct a person to assemble the unassembled kit into a flower product, that is, to assemble the unassembled part of various plants with the unassembled part of various non-plant materials. Alternatively, the unassembled kit may be placed and shipped in multiple boxes.

Alternatively, in the step 54, after receiving or accepting the request, the supplier prepares the unassembled part of various plants for the one of the items TS to be placed in a first box and to be shipped from the supplier to the customer or his or her friends or relatives according to the address listed on the request. In addition, the vendor 9a prepares the instruction manual (optional) and the unassembled part of various non-plant materials for the one of the items TS to be placed in a second box and to be shipped from the vendor 9a to the customer or his or her friends or relatives according to the address listed on the request.

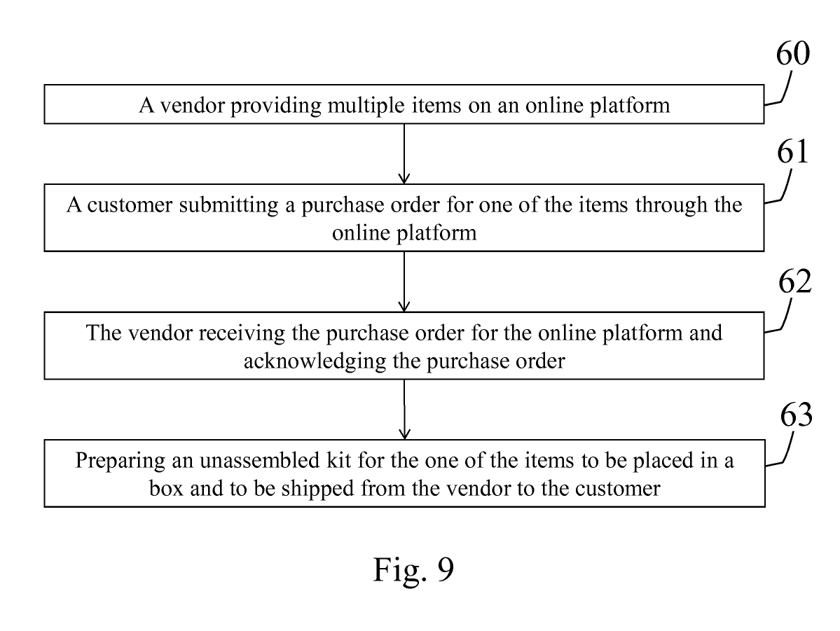

FIG. 9 is a flow chart illustrating a second embodiment of the method of vending or selling the unassembled kit for the customer to assemble the unassembled kit into the flower product. Referring to FIG. 9, in step 60, the vendor 9a may operate the device 6 to provide or present the items TS (including, e.g., the items 10a, 10b, 10c and 10d) on the online platform 8. Next, in step 61, a customer (e.g., the customer 9b or 9c) may operate a software (e.g., the browser 12 or the application program downloaded from the digital distribution platform) installed on a device, such as the device 4a or 4b, to submit a purchase order for one of the items TS, such as the above-mentioned first or second purchase order, to the vendor 9 through the online platform 8. In step 62, after the customer submits the purchase order to the vendor 9a, the vendor 9a receives the purchase order from the online platform 8 and thereafter may acknowledge the purchase order via the online platform 8 or email.

In step 63, after receiving the purchase order for the one of the items TS, the vendor 9a prepares an unassembled, do-it-yourself, or self-assembly kit (e.g., the unassembled one 22 or 34) for the one of the items TS to be placed in a box (e.g., the shipping box 24 or 36) and to be shipped from the vendor 9a to the customer or his or her friends or relatives according to an address listed on the purchase order. The one of the items TS may be the item 10a or 10b. The unassembled kit includes unassembled parts of various plants (including, e.g., one, two or more types of fresh flowers, one, two or more types of flowering plants, and/or stems of leaves) and various non-plant materials (including, e.g., one or more of a rubber band, a ribbon, a metal wire, a pin, a (floral) tape, a tree branch, a glass orb, a piece of foam, and a container) unassembled with the various plants. The one, two or more types of fresh flowers may include agapanthus, allium, alstroemeria, amaryllis, anemones, anthurium, asclepiad, asters, astilbe, baby's breath, bouvardia, calla lilies, campanulas, carnations, celosia, chrysanthemums, clematis, craspedia, curcuma, daffodils, dahlias, delphinium, dianthus, freesia, garden roses, gerber, gerberas, hydrangea, hypericum, iris, kale, lemon leaf, lilies, limonium, matsumoto, orchids, peonies, ranunculus, roses, snapdragon, spray roses, statice, stock, succulents, sunflower, tulips, veronica, waxflowers, cabbage roses, sword fern, solidago, mini-sunflower, israeli ruscus, seeded eucalyptus, liatrus, protea, scabiosa pod, delphinium, italian pitt, and lisianthus. The unassembled part of various plants may be preprocessed (e.g., precut) to have a volume or size less than that of the box and portioned into groups based on their types. An instruction manual, shipped with the unassembled kit or downloaded from the online platform 8, is configured to instruct a person to assemble the unassembled kit into a flower product, that is, to assemble the unassembled part of various plants with the unassembled part of various non-plant materials. Alternatively, the unassembled kit may be placed and shipped in multiple boxes. In an example, the unassembled kit may be shipped from the vendor 9a, such as a brick and mortar store, shop, factory, workshop, or office.

### Other Alternative Embodiment

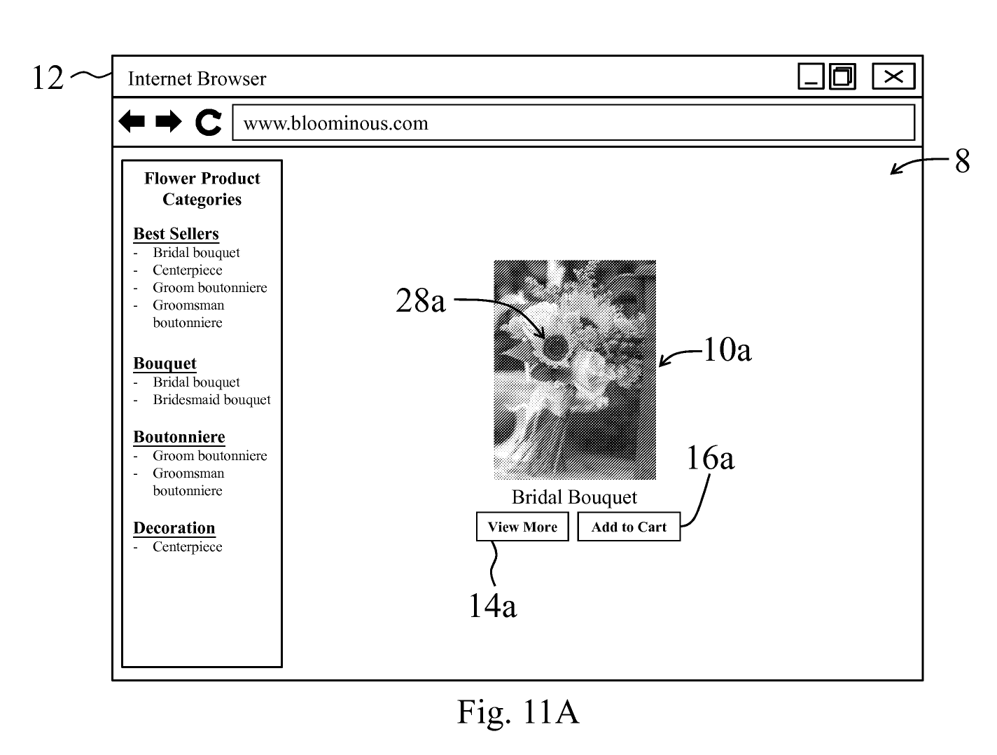

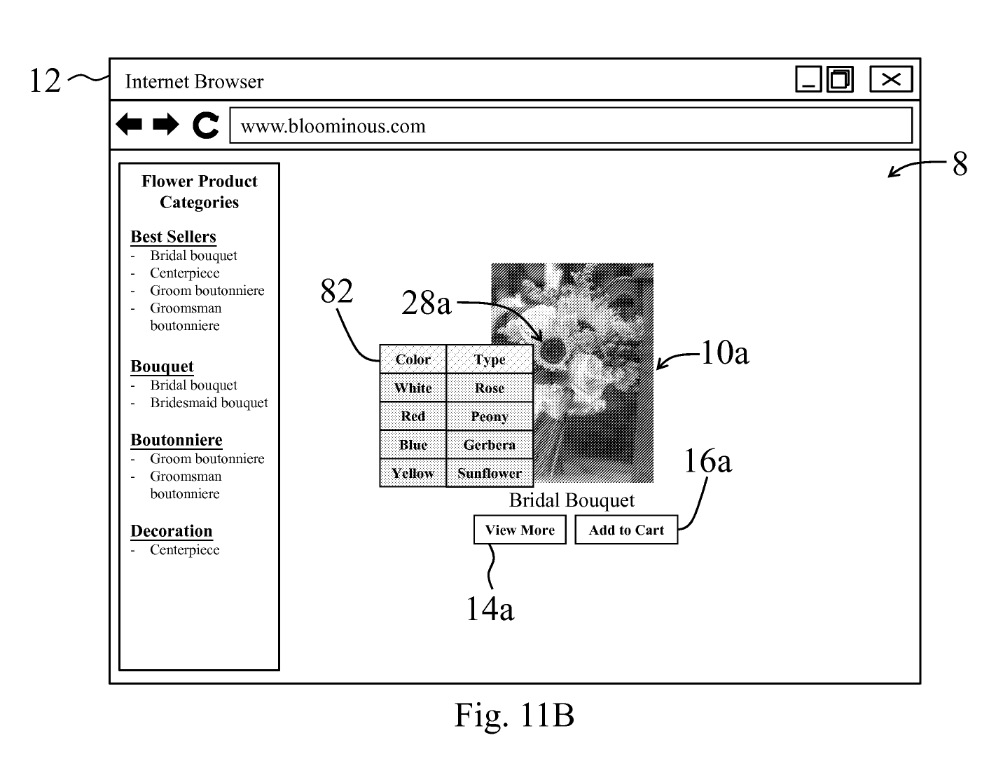

Referring to FIGS. 8, 11A and 11B, in the step 51, before submitting a purchase order for one of the items TS (such as taking the item 10a as an example) to the vendor 9 through the online platform 8, the customer 9b may click on an object of the fresh flower 28a in an image or picture of the item 10a presented or provided on the online platform 8 to list a menu 82, i.e., a list of choices, which may provide options for flower colors (e.g., white, red, blue and yellow) and flower types (e.g., rose, peony, gerbera and sunflower). After the customer 9b clicks on a specific one of the options for flower colors, e.g., red, in the menu 82, the object of the fresh flower 28a in the image or picture of the item 10a changes its color, i.e., yellow, to the selected one, e.g., red. Also, after the customer 9b clicks on a specific one of the options for flower types, e.g., rose, in the menu 82, the object of the fresh flower 28a in the image or picture of the item 10a changes its type, i.e., sunflower, to the selected one, e.g., rose. After selecting the color and type of the fresh flower 28a, the customer 9b may submit a purchase order for the item 10a, including the flower product FB with the fresh flower 28a of the selected color and type, to the vendor 9 through the online platform 8. Accordingly, in the steps 53 and 54, an unassembled kit for the item 10a is provided in accordance with the fresh flower 28a of the selected color and type.

The components, steps, features, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, benefits and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. A method of selling an unassembled kit associated with a flower product, comprising:
providing an item associated with said flower product on an online platform, wherein said item comprises an image of said flower product comprising multiple plants and a non-plant material assembled with said plants, wherein said plants comprise fresh flowers;
receiving a purchase order for said item from said online platform; and
after said receiving said purchase order, shipping said unassembled kit configured to be assembled into said flower product, wherein said unassembled kit comprises said plants and said non-plant material unassembled with said plants.

2. The method of claim 1, wherein said online platform comprises a website.

3. The method of claim 1, wherein said online platform comprises an online store.

4. The method of claim 1, wherein said fresh flowers are of two or more types.

5. The method of claim 1, wherein said fresh flowers comprise roses.

6. The method of claim 1, wherein said plants further comprise flowering plants.

7. The method of claim 1, wherein said plants further comprise one or more stems with leaves but without flowers.

8. The method of claim 1 further comprising shipping an instruction manual with said unassembled kit, wherein said instruction manual is configured to instruct a person to assemble said unassembled kit into said flower product.

9. The method of claim 1, wherein said non-plant material comprises a rubber band.

10. The method of claim 1, wherein said non-plant material comprises a ribbon.

11. The method of claim 1, wherein said non-plant material comprises a metal wire.

12. The method of claim 1, wherein said non-plant material comprises a tape.

13. The method of claim 1, wherein said non-plant material comprises a piece of foam.

14. The method of claim 1, wherein said non-plant material comprises a container.

15. The method of claim 1 further comprising said shipping said unassembled kit in a box.

16. The method of claim 1 further comprising said shipping said unassembled kit from a supplier that is a different company from that of a vendor for selling said unassembled kit.

17. The method of claim 1 further comprising said shipping said unassembled kit from a vendor for selling said unassembled kit.

18. The method of claim 1, wherein said item further comprises a text for said flower product.

19. The method of claim 1, wherein said purchase order is submitted through said online platform.

20. The method of claim 1, after said receiving said purchase order, further comprising acknowledging said purchase order.
